(19) United States
(12) Patent Application Publication
(10) Pub. No.: US 2018/0314012 A1
(43) Pub. Date: Nov. 1, 2018

(54) OPTICAL PLUG CONNECTOR DEVICE

(71) Applicant: Reichle & De-Massari AG, Wetzikon (CH)

(72) Inventors: Christian Gsell, Root (CH); Andreas Rose, Hersborn (DE); Blanca Ruiz, Zurich (CH); Fabian Eggimann, Zurich (CH); Gunter Herr, Ehringshausen (DE); Verena Cerna, Rapperswil (CH)

(21) Appl. No.: 15/769,923

(22) PCT Filed: Oct. 21, 2015
(86) PCT No.: PCT/EP2015/074291

§ 371 Date: Apr. 20, 2018

(51) Int. Cl. G02B 6/38

(52) U.S. Cl. CPC G02B 6/3839; G02B 6/3853; G02B 6/3858; G02B 6/382; G02B 6/3885

(57) ABSTRACT

An optical plug connector device includes at least one lens array and at least one fiber holder, which is designed to position end regions of a plurality of optical fibers relative to the lens array, and which has at least one first fiber holding element wherein the fiber holder comprises at least one second fiber holding element having a higher manufacturing precision than the first fiber holding element.

### PRIOR ART

The invention relates to an optical plug connector device according to Claim 1.

From US 2012/0093462 A1 there is known a multi-fiber plug, which comprises a ferrule and a lens array fashioned as a single piece with the ferrule. Conical channels are devised in the ferrule, which are designed to receive an optical fiber each and to orient the optical fibers relative to the lens array.

Moreover, MPO and MTP ferrules are known in the prior art, in which an orienting of optical fibers is done by means of precision recesses. The making of the precision recesses is done with large manufacturing expense, resulting in high component costs. A play between the precision recesses and optical fibers arranged in the precision recesses cannot be avoided. Moreover, many optical fibers need to be inserted in the individual precision recesses during a manufacturing process, and this insertion process cannot be done by automation. A further drawback of the known MPO and MTP ferrules is the need for high pressing forces, which increase with the number of optical fibers.

The problem which the invention proposes to solve is in particular to provide an optical plug connector device of this kind with advantageous properties in regard to a manufacturing and/or in regard to manufacturing costs. The problem is solved according to the invention by the features of Claim 1, while advantageous embodiments and modifications of the invention will be found in the dependent claims.

### BENEFITS OF THE INVENTION

The invention starts from an optical plug connector device with at least one lens array and with at least one fiber holder, which is designed to position end regions of a plurality of optical fibers relative to the lens array, and which has at least one first fiber holding element.

It is proposed that the fiber holder comprises at least one second fiber holding element, having a higher manufacturing precision than the first fiber holding element.

By an “optical plug connector device” is meant here and in the following in particular a part, in particular a subassembly, of an optical plug connector, in particular an optical plug, and/or an optical cable, in particular a prefabricated optical cable. By a “lens array” is meant in this context a unit comprising a plurality of mechanically interconnected optical lens elements. In particular, the lens elements of the lens array are arranged such that the optical axes of the lens elements run at least substantially parallel to one another. The lens elements may in particular be arranged in a common plane or in several planes which run in particular at least substantially parallel to one another. By “at least substantially parallel” is meant in particular an orientation of a direction relative to a reference direction, in particular in a plane, wherein the direction has a deviation in particular less than 1°, advantageously less than 0.5° and especially advantageously less than 0.3° from the reference direction. By a “lens element” is meant in this context in particular an element which is designed to focus light rays running at least substantially in parallel at a focal point and/or to parallelize and/or focus light rays emanating from a focal point. The lens elements are made in particular of glass, plastic, or another transparent material, having in particular a higher refractive index than air. In particular, the lens elements may be designed as a GRIN lens or a convex lens, in particular a biconvex and/or planoconvex lens. However, other lens types and/or shapes are also conceivable, such as in particular Fresnel lenses and/or liquid lenses and/or liquid crystal lenses. Preferably, all lens elements of the lens array have the same configuration. However, combinations of different lens types and/or shapes within the lens array are also conceivable. By “designed” is meant in particular specially programmed, configured, and/or outfitted. In particular, it shall be meant by an object being designed for a particular function that the object fulfills and/or executes this particular function in at least one application and/or operating state.

By a “fiber holder” shall be meant in this context in particular a unit comprising at least two fiber holding elements, which is designed to receive and/or mechanically secure and/or orient at least substantially parallel to one another a plurality of optical fibers in at least one plane. In particular, the fiber holder is designed to create a defined horizontal spacing between every two immediately adjacent optical fibers and/or a defined vertical spacing between every two immediately adjacent fiber planes. A deviation from a horizontal and/or vertical nominal spacing is in particular less than 5 μm, advantageously less than 3 μm and especially advantageously less than 1 μm. By a “plurality of optical fibers” shall be meant in this context in particular a number of at least eight optical fibers, advantageously at least twelve optical fibers, preferably at least 16 optical fibers and especially preferably at least 32 optical fibers. The fiber holder being designed “to position relatively” the optical fibers to the lens array shall mean in particular that the fiber holder is designed to arrange and/or orient the optical fibers in particular in a mounted state such that a spacing between the optical axes of the optical fibers and a direction of extension of the optical axes of the optical fibers corresponds at least substantially to a spacing and a direction of extension of the optical axes of the lens elements of the lens array. Preferably, the fiber holder is designed to arrange and/or orient the optical fibers such that each time an optical axis of one of the optical fibers is at least substantially congruent with an optical axis of a lens element of the lens array. By “at least substantially congruent” shall be meant in this context in particular that a deviation of an optical axis of one of the optical fibers from an optical axis of a lens element is each time in particular less than 5μm, preferably less than 3 μm and especially preferably less than 1 μm.

By “manufacturing precision” is meant in this context in particular a precision of a manufactured workpiece influenced by machine, process, tool, workpiece and/or environment related factors. Machine-related and/or process-related factors may be in particular different function tolerances of machine elements, inaccuracies of positioning and/or control systems and/or vibrations of a machine system. Tool-related factors may be, for example, tool geometry, tool positioning and/or arrangement, and/or tool wear. Workpiece-related factors may be for example the geometry of a workpiece and/or an intermediate product and/or a microstructure and/or material properties. Environment-related factors may be for example a temperature and/or a humidity. In particular, the manufacturing precision influences directly and/or indirectly a workpiece quality, in particular in regard to at least one dimensional deviation, shape deviation, position deviation and/or roughness deviation. By a second fiber holding element having a “higher manufacturing precision” than a first fiber holding element shall be meant in particular that the second fiber holding element has fewer deviations of at least one nominal value, in particular dimensional deviations, shape deviations, position deviations and/or roughness deviations, than the first fiber holding element in particular by a factor of 10, advantageously by a factor of 50, preferably by a factor of 100 and especially preferably by a factor of 200. In particular, the first fiber holding element and the second fiber holding element are manufactured separately from each other by means of different manufacturing processes and/or they are made from different materials.

Thanks to such a configuration, it is possible to provide an optical plug connector device having advantageous properties with regard to a manufacturing, in particular an automated manufacturing, and/or with regard to manufacturing costs. In particular, the first fiber holding element may be manufactured in greater numbers by means of an advantageously economical and/or simple mass production process, for example by means of an injection molding process, and/or be made from an economical material. The second fiber holding element, having a higher manufacturing precision than the first fiber holding element, can be manufactured in particular in numbers advantageously adapted to needs and in a different manufacturing process. Moreover, an advantageously simple and in particular automated inserting of optical fibers into fiber holding elements can be made possible with high manufacturing quality.

Moreover, it is proposed that the first fiber holding element is designed for a prepositioning and the second fiber holding element for a fine positioning of the optical fibers. By a “prepositioning” is meant in particular an arranging, orienting and/or separating of the optical fibers occurring during a manufacturing process prior to a fine positioning and/or one which occurs spatially in advance of a fine positioning in a finished product, in particular a rough process thereof. By a “fine positioning” is meant in particular an exact orienting of optical axes of the optical fibers to optical axes of lens elements of the lens array. By a “separating” is meant in particular the introducing of a defined spatial distance between the optical fibers. The optical fibers are at first prepositioned by means of the first fiber holding element and then fine positioned by means of the second fiber holding element. Thanks to the prepositioning of the optical fibers, an advantageously simple and/or exact fine positioning of the optical fibers can be done. In particular, a manufacturing process can have an advantageously simple layout in this way and in particular it can be automated.

Furthermore, it is proposed that the second fiber holding element is designed to orient the end regions of the optical fibers relative to the lens array. In particular, the second fiber holding element is designed to orient each time an end region of an optical fiber relative to a corresponding lens element of the lens array. The second fiber holding element has in particular a plurality of recesses which are designed to each accommodate at least one end region of one of the optical fibers. In particular, the second fiber holding element is designed to enclose the end regions of the optical fibers at least partly and preferably entirely in the circumferential direction. This makes possible an advantageously exact orienting of the optical axes of the optical fibers and/or an advantageously secure guidance of the optical fibers in particular in an end region.

In one embodiment of the invention, it is proposed that the first fiber holding element is embodied at least in a two-part implementation. The first fiber holding element comprises in particular at least one base element and at least one cover element. In particular, the base element comprises at least one recess configured to correspond to the cover element, which is designed to accommodate the cover element at least partly and preferably entirely. In particular, the base element and the cover element are joined together in a mounted condition by force locking, form fitting, and/or as a single piece. By “joined as a single piece” is meant in particular an integral bonding, such as one produced by a welding process and/or a gluing process, etc. The base element and the cover element in a mounted condition are intended in particular for a prepositioning and/or separating of the optical fibers and/or in particular for a mechanical fixation of the optical fibers. The optical fibers are inserted into the recess of the base element. The cover element is inserted into the corresponding recess of the base element. The optical fibers are secured in particular by a clamping force between the base element and the cover element. This makes possible an advantageous prepositioning, a separating and/or in particular a mechanical fixation of the optical fibers.

It is furthermore proposed that the fiber holder and the lens array are fabricated as separate components. The fiber holder and the lens array are joined together as a single piece in particular. In particular, the lens array is joined as a single piece to the first fiber holding element and/or to the second fiber holding element. The lens array is oriented in particular mechanically and/or optically relative to the fiber holder. In particular, the lens array is oriented mechanically and/or optically relative to the second fiber holding element. Thanks to the manufacturing of the fiber holder and the lens array as separate components, low manufacturing costs can advantageously be achieved and the components can be produced each time with the requisite precision and/or from a suitable material each time.

Preferably, an index adjustment material is arranged between the lens array and the fiber holder, in particular an index-matching gel and/or an index-matching adhesive. The index adjustment material is designed in particular to reduce optical losses. In particular, the index adjustment material is arranged between the lens array and the second fiber holding element. The lens array is secured in particular by means of the index adjustment material to the fiber holder. In particular, the lens array is secured by means of the index adjustment material to the second fiber holding element. In this way, optical losses can be advantageously reduced, in particular in regard to an insertion attenuation, in particular by reduction of Fresnel reflections. Furthermore, the lower reflection losses contribute to less light being reflected back in a transmission pathway, which advantageously improves a return loss of an optical junction.

Furthermore, it is proposed that the lens array has one-sidedly arranged recesses, which are designed to receive the end regions of the optical fibers. The recesses in particular are arranged on a side of the lens array which is situated opposite the lens elements. In particular, the recesses are fashioned as blind recesses. In particular, the recesses are oriented aligned with the optical axes of the lens elements of the lens array. In particular, the recesses are designed to orient the optical fibers to the lens elements. This makes possible an advantageously precise orienting of the fibers to the lens element of the lens array. Moreover, the number of components and the addition of tolerances can be advantageously reduced.

Furthermore, it is proposed that the first fiber holding element and/or the second fiber holding element is at least substantially plate-shaped. By a “substantially plate-shaped element” is meant in particular a three-dimensional element having, in a developed view in a plane, a nonround cross sectional surface in a cross section perpendicular to the plane and a material thickness, in particular an at least substantially constant material thickness perpendicular to the plane, which is less than 50%, preferably less than 25% and especially preferably less than 10% of a surface extension of the three-dimensional element parallel to the plane, in particular a smallest surface extension of the element parallel to the plane. In particular, at least the second fiber holding element is at least substantially plate-shaped. Thanks to the plate shape, the material needed to manufacture the fiber holding elements can be advantageously reduced to a minimum, so that material costs can be advantageously reduced. Moreover, the plate-shaped configuration allows a making of recesses by means of advantageously simple and/or economical machining methods, in particular on account of the favorable ratio between the diameter and the depth of the recesses being produced.

Furthermore, it is proposed that the fiber holder, in particular the first fiber holding element and/or the second fiber holding element, has at least partially conical recesses, which are designed to at least partially receive the optical fibers. In particular, the recesses are fashioned as through recesses. In particular, the second fiber holding element has at least partially conical recesses, which are designed to receive the end regions of the optical fibers. The optical fibers in particular are led entirely through the recesses. Preferably, the optical fibers are at first led through recesses of the first fiber holding element and then through recesses of the second fiber holding element. In particular, the recesses of the second fiber holding element have a smaller diameter than the recesses of the first fiber holding element. In particular, the optical fibers are led entirely through recesses of the second fiber holding element and cut to length at an exit side, in particular by means of laser cleaving. Thanks to the conical configuration of the recesses and/or the diminishing diameter of the recesses, an advantageously simple, in particular an automated inserting of the optical fibers into the recesses can be accomplished.

In another embodiment of the invention it is proposed that the fiber holder comprises at least one third fiber holding element having a higher manufacturing precision than the first fiber holding element and a lower manufacturing precision than the second fiber holding element. In particular, the third fiber holding element is plate-shaped. Preferably the third fiber holding element has at least partially conical recesses, which are designed to at least partially receive the optical fibers. In particular, the recesses of the third fiber holding element have a smaller diameter than the recesses of the first fiber holding element. The recesses of the second fiber holding element have in particular a smaller diameter than the recesses of the third fiber holding element. In this way, the orienting of the optical fibers can be further simplified. Thanks to the diminishing diameter of the recesses from one fiber holding element to the next fiber holding element, the inserting of the optical fibers can be advantageously simplified and/or advantageously automated, in particular along the optical axis.

Furthermore, it is proposed that the fiber holding elements are arranged, with increasing manufacturing precision, along a direction of longitudinal extension of the optical fibers toward the end regions of the optical fibers. The optical fibers are in particular led at first through recesses of the first fiber holding element, then through recesses of the third fiber holding element and finally through recesses of the second fiber holding element. In particular, the recesses of the third fiber holding element have a smaller diameter than the recesses of the first fiber holding element. The recesses of the second fiber holding element in particular have a smaller diameter than the recesses of the third fiber holding element. By arranging the fiber holding elements with increasing manufacturing precision and decreasing diameter of the recesses, an inserting of the optical fibers can advantageously be easily automated.

Furthermore, it is proposed that the first fiber holding element has at least one separating means, in particular a toothing, which is designed to separate the optical fibers. By the separating means being designed to “separate” the optical fibers is meant in particular that the separating means is designed to introduce a defined spatial distance between the optical fibers. In particular, the separating means is designed to arrange the optical fibers at a distance from each other and at least substantially in parallel with each other. In this way, an advantageous rough first arrangement, in particular a rough prepositioning, of the optical fibers can be achieved. Moreover, it can be advantageously achieved that the corresponding recesses of the next fiber holding element in the optical direction are located with sufficient accuracy, in particular when inserting the optical fibers.

Furthermore, it is proposed that the second fiber holding element is implemented at least substantially from a ceramic material, from a glass, from silicon, a metal and/or a plastic. Preferably, the second fiber holding element is embodied at least substantially of glass and/or silicon. Material combinations should be chosen in particular such that different coefficients of thermal expansion worsen the orienting of optical fibers to corresponding lens elements, in particular in a temperature range of −20° C. to 80° C., by not more than 5 μm, preferably by not more than 3 μm and especially preferably by not more than 1 μm. In this way, an advantageously high manufacturing quality of the second fiber holding element and thus an advantageously exact orienting of the optical fibers can be achieved.

In another embodiment of the invention it is proposed that the first fiber holding element has an accommodation for the second fiber holding element. In this way, an advantageous orienting of the first fiber holding element to the second fiber holding element can be achieved. Preferably, the second fiber holding element is made from a casting compound. By a “casting compound” is meant in this context a compound which is to be worked in a liquid state, being designed to be cured and/or to cure spontaneously after being worked. In particular, the casting compound can be implemented from a casting resin, an adhesive, in particular a binary adhesive, and/or a solder, such as a brazing solder or a soft solder. The optical fibers are arranged in the recess of the first fiber holding element. In particular, the optical fibers are arranged in the recess of the first fiber holding element such that no direct contact exists between the optical fiber holders and the first fiber holding element. The fibers are oriented inside the first fiber holding element by means of orienting units situated outside the first fiber holding element. In one embodiment of the process, the optical fibers are subjected by the orienting unit to a traction force acting along a direction of longitudinal extension of the optical fibers. The casting compound is poured into the recess of the first fiber holding element. After the curing, the casting compound forms the second fiber holding element. In this way, an advantageously economical configuring of the first and the second fiber holding element can be achieved. Moreover, an advantageously long-lasting fixation and orientation of the optical fibers can be achieved.

Furthermore, a prefabricated optical cable is proposed, in particular a patch cable, with at least one optical plug connector device according to the invention.

Preferably, in combination with at least one feature described above or also in particular independently of previously described features, it is proposed that the optical fibers have at least substantially mushroom-shaped thickened end sections, in particular on account of being truncated by means of laser cleaving, which are designed to center end regions of the optical fibers each in at least one recess. In particular, the at least substantially mushroom-shaped thickened end sections are designed to center the end regions of the optical fibers in at least one recess of the second fiber holding element and/or to receive them therein free of play. The at least one recess has in particular an at least substantially circular exit opening. The optical fibers are led in particular entirely through a recess. At an exit side, the optical fibers are cut to length, in particular by means of laser cleaving. The optical fibers are pushed back or pulled contrary to the lead-through direction in exit openings of the recesses. The end regions of the optical fibers are centered by the mushroom-shaped thickened end sections in the recesses. Thanks to the centering of the end regions of the optical fibers in the recesses, an advantageously precise and play-free orienting of the optical fibers can be accomplished.

Furthermore, a method for manufacturing an optical plug connector device with at least one lens array and with at least one fiber holder is proposed, which has at least one first fiber holding element and at least one second fiber holding element having a higher manufacturing precision than the first fiber holding element, wherein end regions of a plurality of optical fibers are positioned relative to the lens array by means of the fiber holder. In this way, an advantageously simple and/or economical manufacturing can be accomplished, which can be advantageously easily automated or at least partly automated.

### DRAWING

Further benefits will emerge from the following description of drawings. The drawings represent three sample embodiments of the invention. The description and the claims contain many features in combination. The skilled person will also advisedly consider the features individually and put them together in further meaningful combinations.

There are shown:

FIG. 1 a configured optical cable with an optical plug connector device, having a lens array and a fiber holder for the positioning of a plurality of optical fibers relative to the lens array,

FIG. 2 a first fiber holding element of the fiber holder of FIG. 1 in a nonassembled state,

FIG. 3 a base element of the first fiber holding element with inserted optical fibers,

FIG. 4 the first fiber holding element in an assembled state,

FIG. 5 the fiber holder with first fiber holding element and a second fiber holding element,

FIG. 6 the base element of the first fiber holding element, the second fiber holding element and a lens array arranged on the second fiber holding element,

FIG. 7 a partial cross section of the second fiber holding element,

FIG. 8 a configured optical cable with an alternative optical plug connector device, having a lens array and a fiber holder for the positioning of a plurality of optical fibers relative to the lens array,

FIG. 9 a first step of the method for manufacturing the optical plug connector device of FIG. 8,

FIG. 10 a second step of the method for manufacturing the optical plug connector device of FIG. 8,

FIG. 11 a third step of the method for manufacturing the optical plug connector device of FIG. 8,

FIG. 12 a fourth step of the method for manufacturing the optical plug connector device of FIG. 8,

FIG. 13 a configured optical cable with another alternative optical plug connector device, having a lens array and a fiber holder with three fiber holding elements for the positioning of a plurality of optical fibers relative to the lens array and

FIG. 14 the lens array of FIG. 13 in a cross section representation.

### DESCRIPTION OF THE SAMPLE EMBODIMENTS

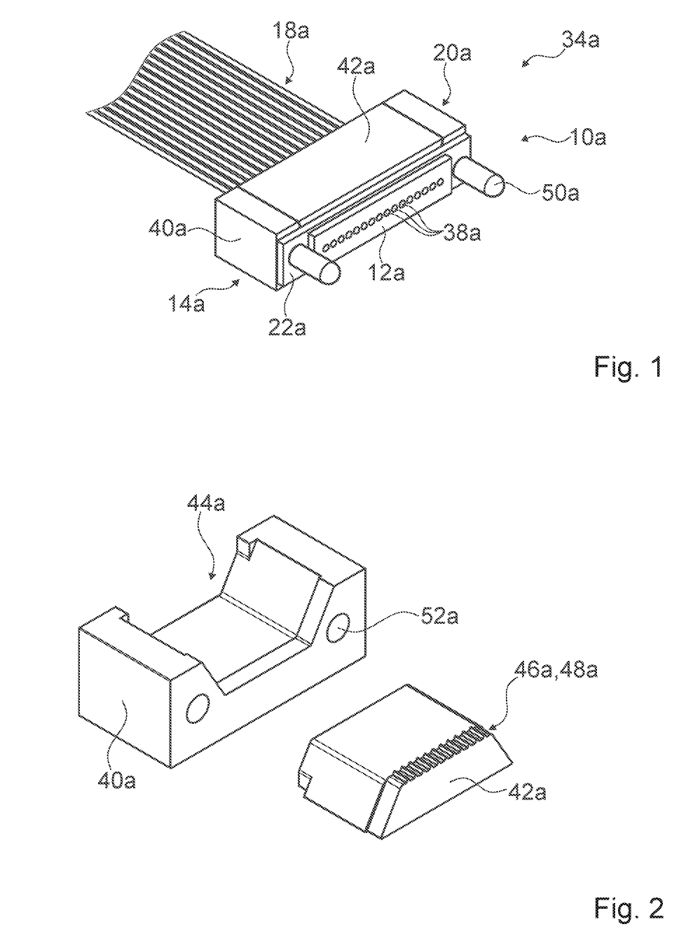

FIG. 1 shows a configured optical cable 34a, in particular an optical patch cable. The optical cable 34a comprises an optical plug connector device 10a and a plurality of optical fibers 18a. The optical plug connector device 10a has a lens array 12a. The lens array 12a comprises a plurality of optical lens elements 38a. The number of lens elements 38a of the lens array 12a corresponds to the number of optical fibers 18a. Alternatively, the number of lens elements may differ from the number of optical fibers and in particular be greater than the number of optical fibers. Moreover, the optical plug connector device 10a has a fiber holder 14a. The fiber holder 14a is designed to position end regions 16a (not visible in FIG. 1) of the optical fibers 18a relative to the lens array 12a. The fiber holder 14a and the lens array 12a are produced as separate components. Between the lens array 12a and the fiber holder 14a there is arranged an index adjustment material, in particular an index-matching gel, an index-matching adhesive and/or an index-matching film. The fiber holder 14a comprises a first fiber holding element 20a and a second fiber holding element 22a. The second fiber holding element 22a has a higher manufacturing precision than the first fiber holding element 20a. The first fiber holding element 20a is designed for a prepositioning and the second fiber holding element 22a for a fine positioning of the optical fibers 18a. The first fiber holding element 20a is embodied in a two-part implementation. The first fiber holding element 20a comprises a base element 40a and a cover element 42a. The second fiber holding element 22a is plate-shaped. The second fiber holding element 22a is made of a ceramic material, a glass, silicon, a metal and/or a plastic. Preferably, the second fiber holding element 22a is made of a glass and/or silicon.

FIG. 2 shows the base element 40a and the cover element 42a of the first fiber holding element 20a in a non-assembled state. The base element 40a has a recess 44a corresponding to the cover element 42a, which is designed to receive the cover element 42a. The first fiber holding element 20a has a separating means 46a, which is designed to separate the optical fibers 18a. The separating means 46a is fashioned as a toothing 48a arranged on the cover element 42a. Alternatively or additionally, a separating means can likewise be arranged on a base element of a first fiber holding element.

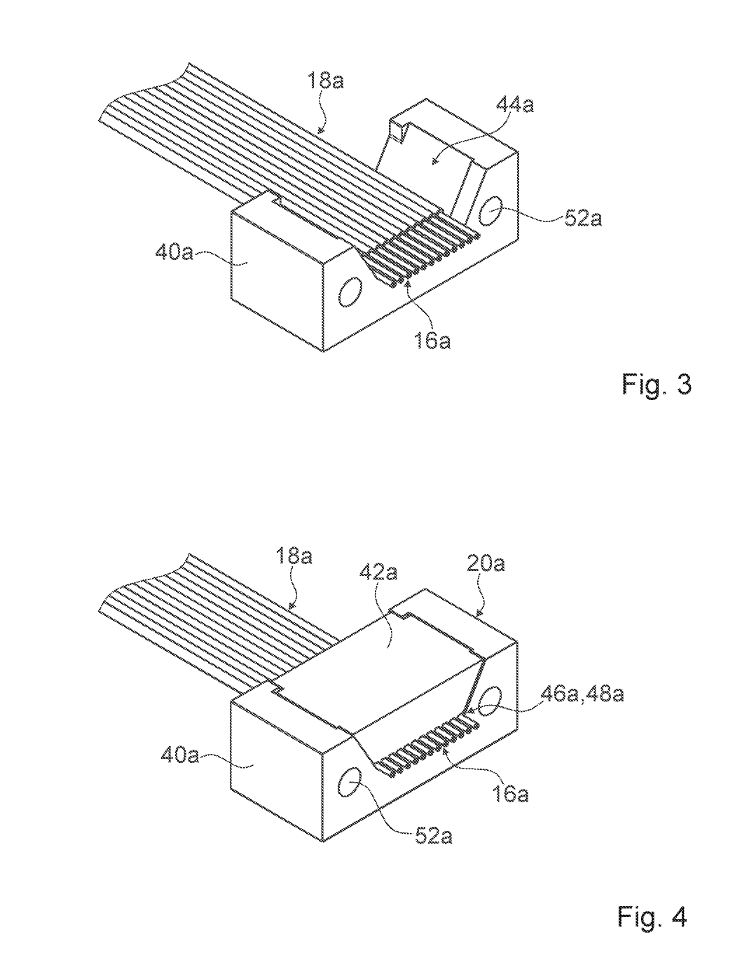

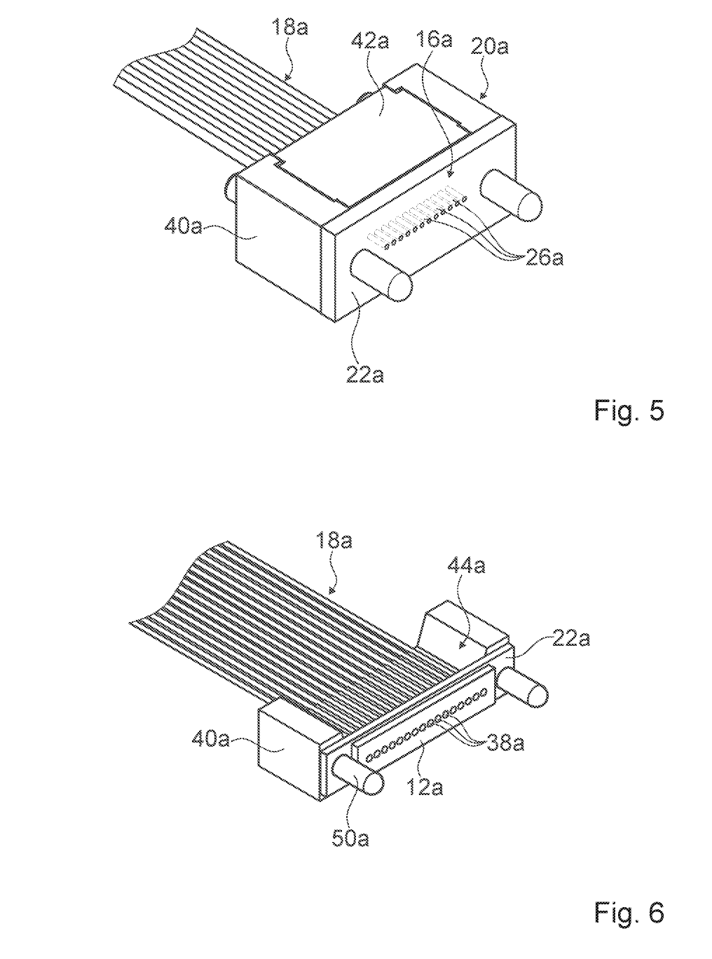

FIGS. 3 to 7 represent steps in the method of manufacturing the optical plug connector device 10a. The optical fibers 18a as shown in FIG. 3 and the base element 40a of the first fiber holding element 20a are inserted. The end regions 16a of the optical fibers 18a stick out beyond the base element 40a. The cover element 42a is installed in the recess 44a of the base element 40a (cf. FIG. 4). The optical fibers 18a are mechanically secured between the cover element 42a and the base element 40a. The optical fibers 18a are separated from each other by the separating means 46a. Alternatively, only a separating of the optical fibers may also be done, omitting the mechanical securing of the optical fibers. In the assembled state of the first fiber holding element 20a shown in FIG. 4, the optical fibers 18a are prepositioned by means of the first fiber holding element 20a. Spatial regions in which the optical fibers are situated after a prepositioning are in particular smaller than a spatial extension of the recesses of the second element at an entry side, while the corresponding regions are at least substantially aligned.

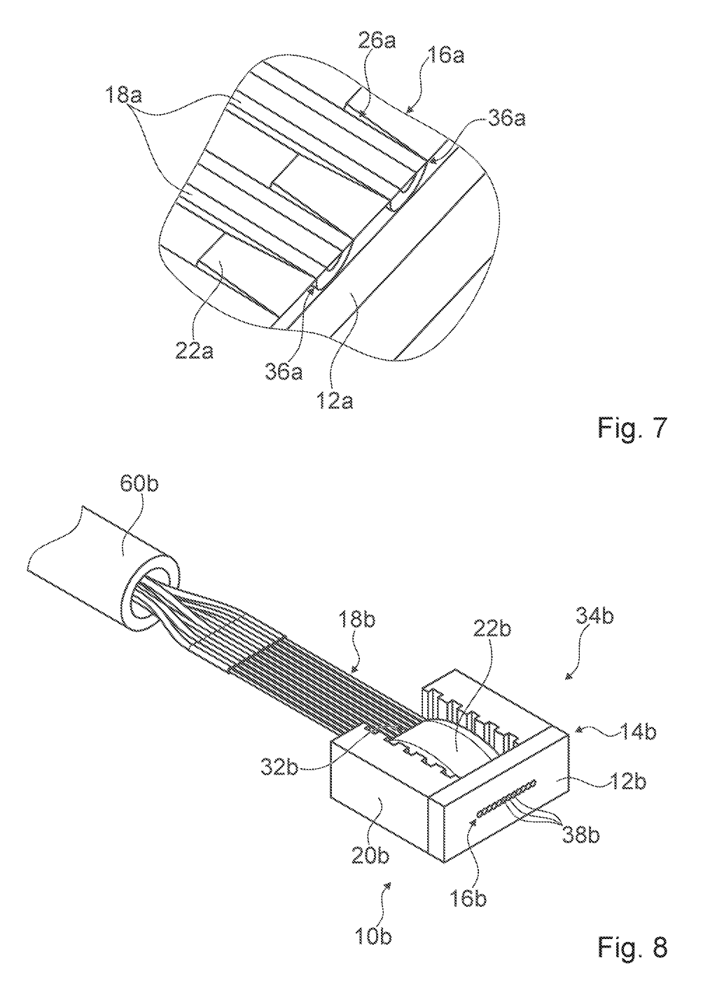

The second fiber holding element 22a is shoved onto the end regions 16a of the prepositioned optical fibers 18a (cf. FIG. 5). A guiding of the second fiber holding element 22a during this process is done by two guide elements 50a previously introduced into corresponding accommodations 52a in the base element 40a of the first fiber holding element 20a. Alternatively, guide elements may also be embodied as a single piece with a first fiber holding element, in particular with a base element of a first fiber holding element. Alternatively, it is likewise conceivable that guide elements are arranged in a second fiber holding element and/or fashioned as a single piece with a second fiber holding element. The second fiber holding element 22a has conical recesses 26a, which are designed to receive the optical fibers 18a, in particular the end regions 16a of the optical fibers 18a. The recesses 26a are conical in shape, at least in a partial region, in particular in an inserting region. Thanks to the conical shape of the recesses 26a, the second fiber holding element 22a can advantageously be shoved on easily. The second fiber holding element 22a is designed to orient the end regions 16a of the optical fibers 18a relative to the lens array 12a. After shoving on the second fiber holding element 22a, the optical fibers 18a are cut to length by means of laser cleaving. Thanks to the laser cleaving, mushroom-shaped thickened end sections 36a (cf. FIG. 7) are implemented on the optical fibers 18a. Alternatively, optical fibers may also be cut to length by means of another method, such as machining.

As is represented in FIG. 6, the lens array 12a is mounted on the second fiber holding element 22a. Prior to this, an index adjustment material is applied to the lens array 12a and/or to the second fiber holding element 22a, in particular an index-matching adhesive. Before mounting the lens array 12a on the second fiber holding element 22a, the cover element 42a is removed from the base element 40a of the first fiber holding element 20a, thereby releasing the mechanical fixation of the optical fibers 18a. If there is no mechanical fixation of the optical fibers 18a between the base element 40a and the cover element 42a, the removal of the cover element 42a may be omitted. By the mounting of the lens array 12a on the second fiber holding element 22a, the optical fibers 18a are shoved back into the conical recesses 26a of the second fiber holding element 22a. Alternatively, the optical fibers 18a may be pulled back into the conical recesses 26a of the second fiber holding element 22a prior to the mounting of the lens array 12a. The mushroom-shaped thickened end sections 36a of the optical fibers 18a are designed to center the end regions 16a of the optical fibers 18a in the conical recesses 26a and/or to minimize the play of the end regions 16a of the optical fibers 18a in the conical recesses 26a (cf. FIG. 7). The cover element 42a is once more inserted into the base element 40a of the first fiber holding element 20a, thereby restoring the mechanical fixation of the optical fibers 18a. Finally, the lens array 12a is positioned on the second fiber holding element 22a. The positioning of the lens array 12a may be done actively optically and/or by means of optical orienting marks, for example. Alternatively or additionally, a positioning of a lens array may be done via the guide elements 50a.

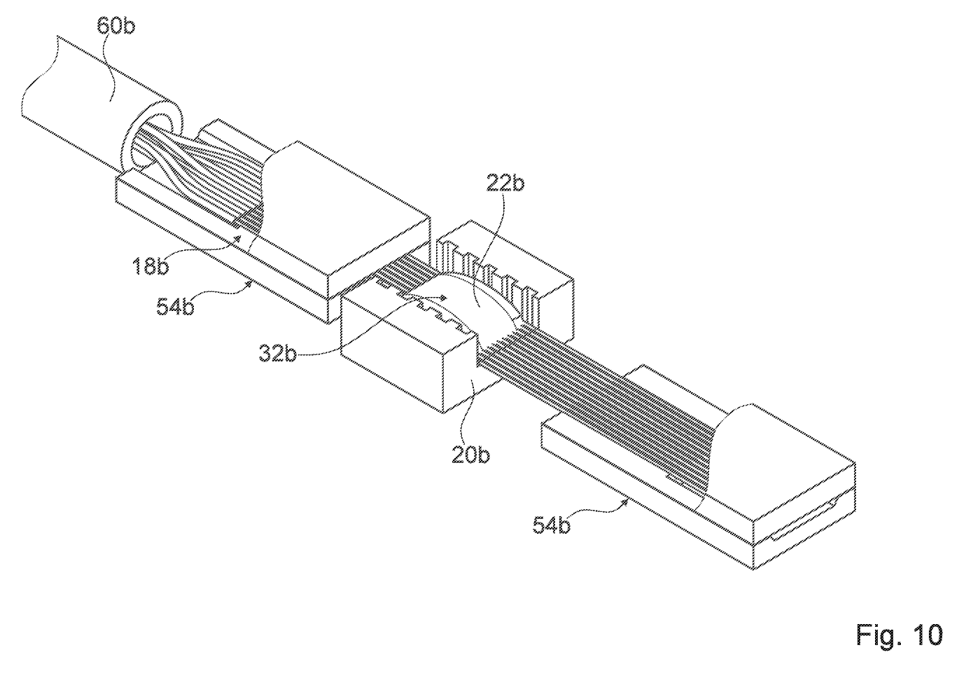

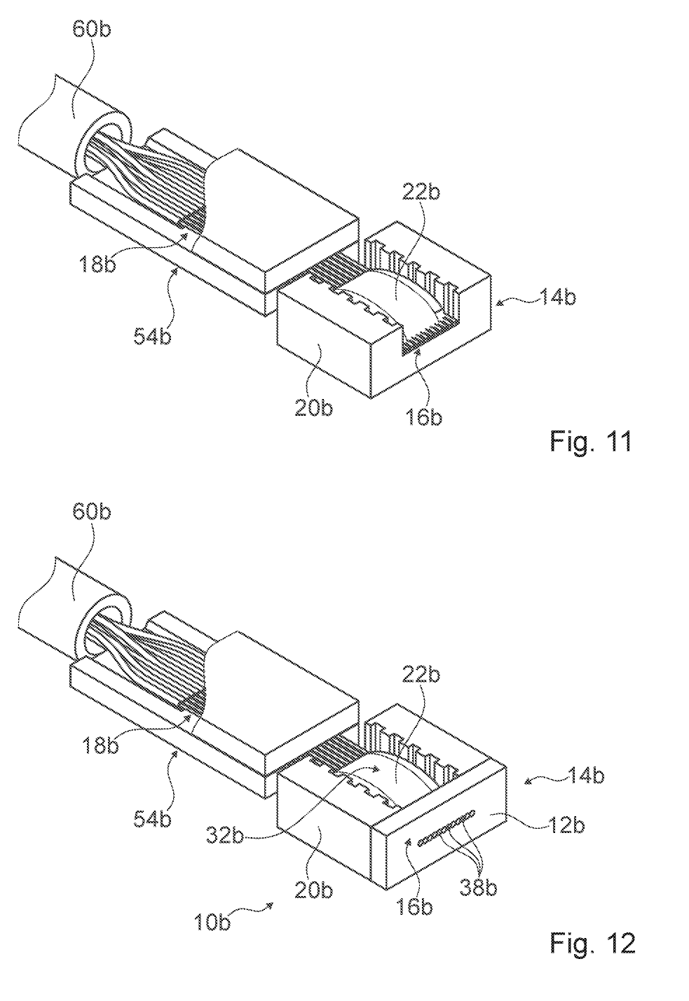

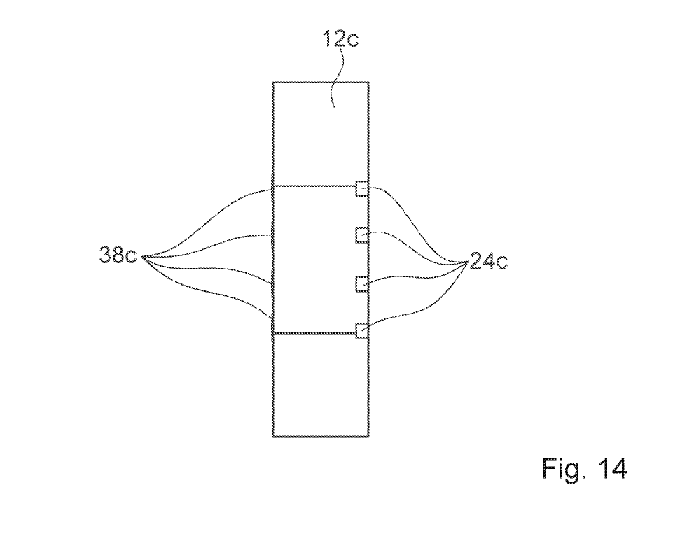

FIGS. 8 to 14 show two further sample embodiments of the invention. The following descriptions and drawings are substantially confined to the differences between the sample embodiments, so that one may basically refer to the drawings and/or the description of the other sample embodiments, in particular FIGS. 1 to 7, with respect to components of the same designation, in particular with respect to components having the same reference numbers. In order to differentiate between the sample embodiments, the letter a has been placed in the reference numbers of the sample embodiment in FIGS. 1 to 7. In the sample embodiments of FIGS. 8 and 14, the letter a has been replaced by the letters b and c.

FIG. 8 shows a configured optical cable 34b with an alternative optical plug connector device 10b and a plurality of optical fibers 18b. The optical plug connector device 10b has a lens array 12b. The lens array 12b comprises a plurality of optical lens elements 38b. The number of lens elements 38b of the lens array 12b corresponds to the number of optical fibers 18b. Alternatively, the number of lens elements may differ from the number of optical fibers and in particular be greater than the number of optical fibers. Moreover, the optical plug connector device 10b has a fiber holder 14b. The fiber holder 14b is designed to position end regions 16b of the optical fibers 18b relative to the lens array 12b. The fiber holder 14b and the lens array 12b are produced as separate components. Between the lens array 12b and the fiber holder 14b there is arranged an index adjustment material, in particular an index-matching gel and/or an index-matching adhesive. The fiber holder 14b comprises a first fiber holding element 20b and a second fiber holding element 22b. The second fiber holding element 22b has a higher manufacturing precision than the first fiber holding element 20b. The first fiber holding element 20b is designed for a prepositioning and the second fiber holding element 22b for a fine positioning of the optical fibers 18b. The first fiber holding element 20b comprises an accommodation 32b for the second fiber holding element 22b. The second fiber holding element 22b is made from a casting compound.

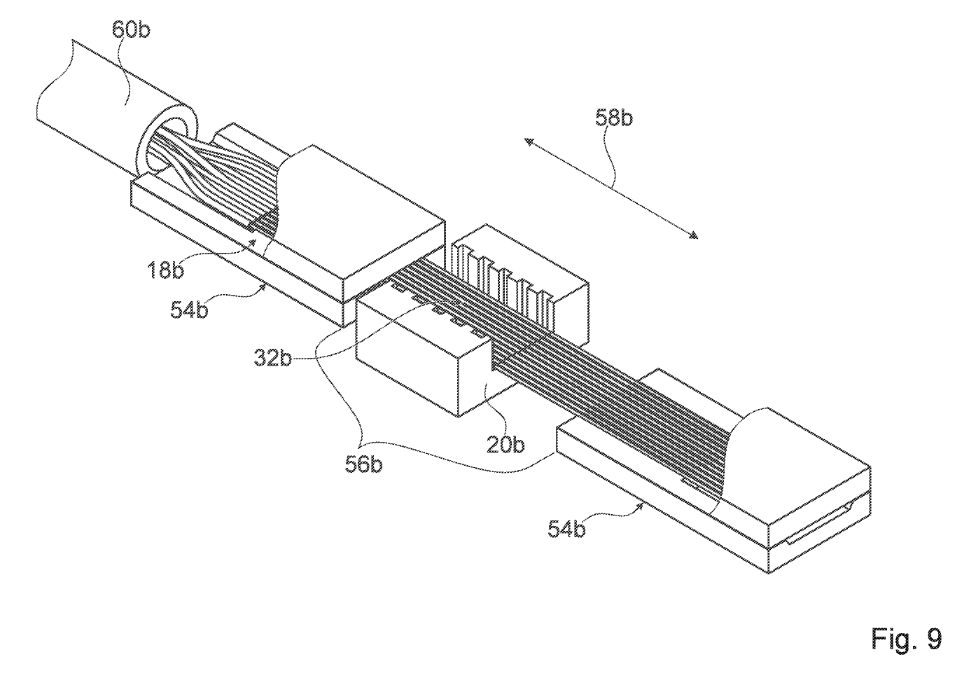

FIGS. 9 to 12 represent steps in the method of manufacturing the optical plug connector device 10b. As is shown in FIG. 9, a jacket is removed from the optical fibers 18b. The optical fibers 18b are inserted and secured in two orienting units 54b, each of which has a high manufacturing precision. The orienting units 54b are oriented relative to each other in particular with high precision. The orienting units 54b each have a plurality of parallel extending V-grooves, which are designed to receive the optical fibers 18b. The optical fibers 18b are led free in a region 56b between the orienting units 54b. By means of the orienting units 54b, a traction force 58b is applied to the optical fibers 18b. The first fiber holding element 20b is arranged and/or oriented in the region 56b between the orienting units 54b, so that the optical fibers 18b run through the accommodation 32b.

The accommodation 32b in a further step of the method is filled with a casting compound, such as a UV-curing adhesive, and the casting compound is cured. After the curing, the casting compound forms the second fiber holding element 22b. After the curing of the casting compound, the orienting unit 54b arranged at a side of the fiber holder 14b facing away from a cable 60b is removed and the optical fibers 18b are cut to length flush with the fiber holder 14b, for example by means of laser cleaving. Alternatively, a piece of the fiber holder 14b may additionally be removed. As shown in FIG. 12, in a further step of the method the lens array 12b is positioned on the fiber holder 14b. The positioning of the lens array 12b may be done actively optically and/or by means of optical orienting marks, for example. Alternatively or additionally, a positioning of a lens array may be done by guide elements, not shown here. A fixation of the lens array 12b is done preferably by means of a UV-curing adhesive. After the fixation of the lens array 12b, the second orienting unit 54b is removed.

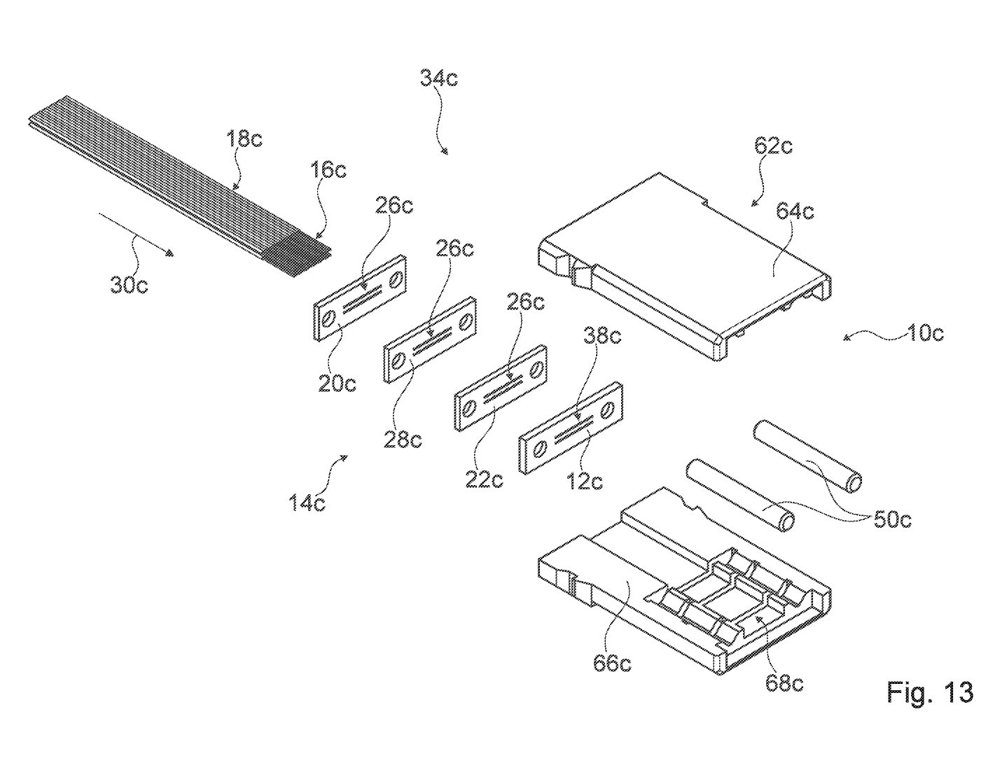

FIG. 13 shows an exploded view of a configured optical cable 34c with another alternative optical plug connector device 10c and a plurality of optical fibers 18c. The optical plug connector device 10c has a lens array 12c. The lens array 12c comprises a plurality of optical lens elements 38c. The number of lens elements 38c of the lens array 12c corresponds to the number of optical fibers 18c. Alternatively, the number of lens elements may differ from the number of optical fibers and in particular be greater than the number of optical fibers. FIG. 14 shows a cross sectional representation of the lens array 12c. The lens array 12c has onesidedly arranged recesses 24c, which are designed to receive end regions 16c of the optical fibers 18c.

Moreover, the optical plug connector device 10c has a fiber holder 14c. The fiber holder 14c is designed to position the end regions 16c of the optical fibers 18c relative to the lens array 12c. The fiber holder 14c and the lens array 12c are produced as separate components. The fiber holder 14c comprises a first fiber holding element 20c and a second fiber holding element 22c. The second fiber holding element 22c has a higher manufacturing precision than the first fiber holding element 20c. The first fiber holding element 20c is designed for a prepositioning and the second fiber holding element 22c for a fine positioning of the optical fibers 18c. Moreover, the fiber holder 14c has a third fiber holding element 28c having a higher manufacturing precision than the first fiber holding element 20c and a lower manufacturing precision than the second fiber holding element 22c. Alternatively, a fiber holder may also have more or fewer fiber holding elements. The fiber holding elements 20c, 22c, 28c are arranged with increasing manufacturing precision along a direction of longitudinal extension 30c of the optical fibers 18c toward the end regions 16c of the optical fibers 18c. The fiber holding elements 20c, 22c, 28c are plate-shaped. The fiber holding elements 20c, 22c, 28c each have conical recesses 26c, which are designed to at least partially receive the optical fibers 18c. A mechanical orienting of the fiber holding elements 20c, 22c, 28c and the lens array 12c is done by guide elements 50c. The diameters of the recesses 26c diminish in the direction from the first fiber holding element 20c to the third fiber holding element 28c to the second fiber holding element 22c.

The configured optical cable 34c moreover comprises a housing 62c, having a housing upper shell 64c and a housing lower shell 66c. The housing 62c has accommodations 68c which are designed to hold the lens array 12c, the fiber holding elements 20c, 22c, 28c and the guide elements 50c. Intermediate spaces between the fiber holding elements 20c, 22c, 28c are filled with an adhesive, so that a compound unit is realized. Optionally, an index-matching gel or index-matching adhesive can be placed between the end regions 16c of the optical fibers 18c and the lens array 12c.

1. An optical plug connector device with at least one lens array and with at least one fiber holder which is designed to position end regions of a plurality of optical fibers relative to the lens array and which has at least one first fiber holding element, wherein the fiber holder comprises at least one second fiber holding element having a higher manufacturing precision than the first fiber holding element.

2. The optical plug connector device according to claim 1, wherein the first fiber holding element is designed for a prepositioning and the second fiber holding element for a fine positioning of the optical fibers.

3. The optical plug connector device according to claim 1, wherein the second fiber holding element is designed to orient the end regions of the optical fibers relative to the lens array.

4. The optical plug connector device according to claim 1, wherein the first fiber holding element is embodied at least in a two-part implementation.

5. The optical plug connector device according to claim 1, wherein the fiber holder and the lens array are fabricated as separate components.

6. The optical plug connector device according to claim 1, wherein an index adjustment material is arranged between the lens array and the fiber holder.

7. The optical plug connector device according to claim 1, wherein the lens array has one-sidedly arranged recesses which are designed to receive the end regions of the optical fibers.

8. The optical plug connector device according to claim 1, wherein the first fiber holding element and/or the second fiber holding element is at least substantially plate-shaped.

9. The optical plug connector device according to claim 1, wherein the fiber holder has at least partially conical recesses, which are designed to at least partially receive the optical fibers.

10. The optical plug connector device according to claim 1, wherein the fiber holder comprises at least one third fiber holding element having has a higher manufacturing precision than the first fiber holding element and a lower manufacturing precision than the second fiber holding element.

11. The optical plug connector device according to claim 1, wherein the fiber holding elements are arranged, with increasing manufacturing precision, along a direction of longitudinal extension of the optical fibers toward the end regions of the optical fibers.

12. The optical plug connector device according to claim 1, wherein the first fiber holding element has at least one separating means, which is designed to separate the optical fibers.

13. The optical plug connector device according to claim 1, wherein the second fiber holding element is implemented at least substantially from a ceramic material and/or from a glass and/or silicon and/or metal and/or plastic.

14. The optical plug connector device according to claim 1, wherein the first fiber holding element has an accommodation for the second fiber holding element.

15. The optical plug connector device according to claim 12, wherein the second fiber holding element is made from a casting compound.

16. A prefabricated optical cable with at least one optical plug connector device according to claim 1.

17. The prefabricated optical cable according to claim 16, comprising the optical fibers which have at least substantially mushroom-shaped thickened end sections, which are designed to center end regions of the optical fibers each in at least one recess.

18. A method for manufacturing an optical plug connector device, in particular according to claim 1, with at least one lens array and with at least one fiber holder which has at least one first fiber holding element and at least one second fiber holding element having a higher manufacturing precision than the first fiber holding element, wherein end regions of a plurality of optical fibers are positioned relative to the lens array by means of the fiber holder.
